(19) United States
(12) Patent Application Publication
(10) Pub. No.: US 2017/0168210 A1
(43) Pub. Date: Jun. 15, 2017

(54) BACKLIGHT MODULE, DISPLAY MODULE, AND DISPLAY DEVICE

(71) Applicants: Le Holdings (Beijing) Co., Ltd., Beijing (CN); LE SHI ZHI XIN ELECTRONIC TECHNOLOGY (TIAN JIN) LIMITED, Tianjin (CN)

(72) Inventor: Zhishuai Jia, Tianjin (CN)

(73) Assignees: Le Holdings (Beijing) Co., Ltd., Beijing (CN); LE SHI ZHI XIN ELECTRONIC TECHNOLOGY (TIAN JIN) LIMITED, Tianjin (CN)

(21) Appl. No.: 15/240,424

(22) Filed: Aug. 18, 2016

Related U.S. Application Data
(63) Continuation of application No. PCT/CN2016/088971, filed on Jul. 6, 2016.

(30) Foreign Application Priority Data
Dec. 10, 2015 (CN) 201521036231.4

(51) Int. Cl. F21V 8/00

(52) U.S. Cl. CPC G02B 6/005; G02B 6/0068; G02B 6/0073

(57) ABSTRACT

Disclosed are a backlight module, a display module, and a display device. The backlight module includes a light guide plate, a first LED lamp bar, and a second LED lamp bar, wherein: the light guide plate includes dimming zones in three rows and several columns; the first LED lamp bar is arranged on the side of the light guide plate close to the first row of dimming zones; and the second LED lamp bar is arranged on the side of the light guide plate close to the third row of dimming zones. With the technical solution above, local dimming of the backlight module can be achieved to thereby improve the quality of a picture on the display device, and lower power consumption thereof.

### CROSS REFERENCE TO RELATED APPLICATIONS

This application is a continuation of International Application No. PCT/CN2016/088971, filed on Jul. 6, 2016, which is based upon and claims priority to Chinese Patent Application No. 201521036231.4, filed on Dec. 10, 2015, the entire contents of which are incorporated herein by reference.

### TECHNICAL FIELD

The disclosure relates to the field of display technologies, and particularly to a backlight module, a display module, and a display device.

### BACKGROUND

At present, Light Emitting Diodes (LEDs) are commonly used as light sources in a backlight module of a liquid crystal display device. The backlight module can be categorized into a direct-lit backlight module, and an edge-lit backlight module, dependent upon the positions where the light sources are distributed, where the light sources in the direct-lit backlight module are distributed at the bottom of a light guide plate, and such a backlight module is generally applicable to a display, a TV set, or another liquid crystal display device with a large size; and the light sources in the edge-lit backlight module are distributed on the sides of a light guide plate, and such a backlight module is generally applicable to a notebook PC, a tablet PC, a mobile phone, or another display device with a small size. As the LED related technologies are developing constantly, the edge-lit backlight module is also coming to be applicable to a display device with a large size to thereby bring a better visual experience of a user.

In the traditional edge-lit backlight module, the entire picture is lightened or darkened globally and local dimming can not be realized, thus making it impossible to achieve the optimum contrast of the picture on the display device, which may degrade the effect of displaying the picture; and on the other hand, if the picture is displayed in black in some area on the display device, the light sources may remain bright, thus resulting in high power consumption.

### SUMMARY

The disclosure provides a backlight module, a display module, and a display device to thereby enable local dimming of the backlight module so as to improve the quality of a picture on the display device, and to lower power consumption thereof.

An embodiment of the disclosure provides a backlight module including a light guide plate, a first LED lamp bar, and a second LED lamp bar, wherein:
the light guide plate includes dimming zones in three rows and several columns, wherein a first coating including an ultraviolet absorbent and yellow phosphor is arranged on a light-exiting surface of the first row of dimming zones; and a second coating including a blue light absorbent and white phosphor is arranged on a light-exiting surface of the second row of dimming zones;
the first LED lamp bar is arranged on the side of the light guide plate close to the first row of dimming zones, and includes blue light LED lamp strings arranged corresponding to the columns of dimming zones, and configured with separate control circuits; and
the second LED lamp bar is arranged on the side of the light guide plate close to the third row of dimming zones, and includes white light LED lamp strings and ultraviolet LED lamp strings arranged corresponding to the columns of dimming zones, and configured with separate control circuits.

In the technical solutions according to the embodiments of the disclosure, blue light emitted by any one of the blue light LED lamp strings in the first LED lamp bar enters the light guide plate so that the blue light can excite the yellow phosphor in the dimming zone in the first row and the corresponding column to generate white light, and is absorbed by the blue absorbent in the dimming zone in the second row and the corresponding column, and thus can not enter the dimming zone in the third row and the corresponding column; white light emitted by any one of the white light LED lamp strings in the second LED lamp bar enters the light guide plate so that the white light can be transmitted and emitted from the light-exiting surface of the dimming zone in the third row and the corresponding column; and ultraviolet light emitted by any one of the ultraviolet LED lamp strings in the second LED lamp bar enters the light guide plate so that the ultraviolet light can excite the white phosphor in the dimming zone in the second row and the corresponding column to generate white light, and is absorbed by the ultraviolet absorbent in the dimming zone in the first row and the corresponding column. As can be apparent, with this structural design, the light emitted from the respective dimming zones of the light guide plate is white light, and since the control circuits of the respective blue light LED lamp strings, white light LED lamp strings 1, and ultraviolet LED lamp strings are separate, the brightness of the respective strings of lamps can be controlled by controlling their voltage to thereby achieve local dimming of the backlight module so as to improve the quality of a display on the display device, and to low power consumption thereof.

An embodiment of the disclosure further provides a display module including the backlight module according to any one of the technical solutions above. The backlight module in the display module can enable local dimming to thereby improve the quality of a picture on the display device, and low power consumption thereof.

An embodiment of the disclosure further provides a display device including the display module according to the technical solution above. The display device can have a higher quality of a picture, and low power consumption.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a top view of a light guide plate and bars of lamps in a backlight module according to an embodiment of the disclosure; and

FIG. 2 is a sectional view along A-A in FIG. 1.

### REFERENCE NUMERALS

1—Light guide plate

2—First LED lamp bar

3—Second LED lamp bar

11—First coating

11a—Ultraviolet absorbent layer

11b—Yellow phosphor layer

12—Second coating

12a—Blue light absorbent layer

12b—White phosphor layer

21—Blue light LED lamp string

31—White light LED lamp string

32—Ultraviolet LED lamp string

### DETAILED DESCRIPTION

In order to make the objects, technical solutions, and advantages of the embodiments of the invention more apparent, the technical solutions according to the embodiments of the invention will be described below clearly and fully with reference to the drawings in the embodiments of the invention, and apparently the embodiments described below are only a part but not all of the embodiments of the invention. Based upon the embodiments here of the invention, all the other embodiments which can occur to those skilled in the art without any inventive effort shall fall into the scope of the invention.

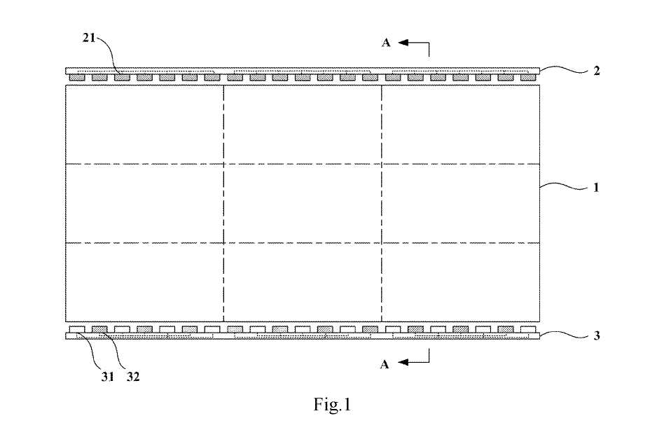

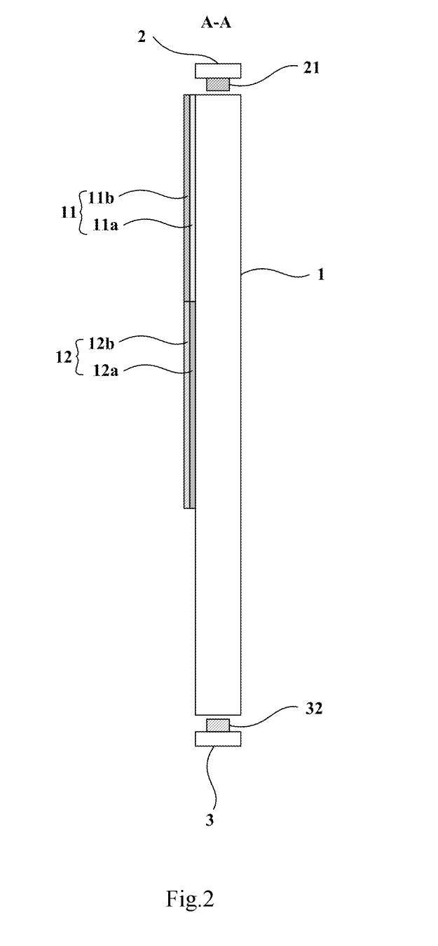

As illustrated in FIG. 1 and FIG. 2, a backlight module according to an embodiment of the disclosure includes a light guide plate 1, a first LED lamp bar 2, and a second LED lamp bar 3, where:

The light guide plate 1 includes dimming zones in three rows and several columns, where a first coating 11 including an ultraviolet absorbent and yellow phosphor is arranged on a light-exiting surface of the first row of dimming zones; and a second coating 12 including a blue light absorbent and white phosphor is arranged on a light-exiting surface of the second row of dimming zones;

The first LED lamp bar 2 is arranged on the side of the light guide plate 1 close to the first row of dimming zones, and includes blue light LED lamp strings 21 arranged corresponding to the columns of dimming zones, and configured with separate control circuits; and

The second LED lamp bar 3 is arranged on the side of the light guide plate 1 close to the third row of dimming zones, and includes white LED lamp strings 31 and ultraviolet LED lamp strings 32 arranged corresponding to the columns of dimming zones, and configured with separate control circuits.

In addition to the light guide plate, the first LED lamp bar, and the second LED lamp bar above, the structure of the backlight module typically further includes a back plate, a reflector plate, an optical film sheet, a glue frame, etc., where the back plate includes an accommodation space in which the reflector plate, the light guide plate, and the optical film sheet are arranged in that order, the first LED lamp bar and the second LED lamp bar are located respectively between two opposite light incidence side end face of the light guide plate, and sidewalls of the back plate.

The backlight module according to the embodiment of the disclosure can achieve local dimming, where the light guide plate includes the dimming zones in three rows and several columns. The embodiment of the disclosure will not be limited to any particular number of columns of dimming zones, for example, there may be two, three, four, etc., columns of dimming zones, and if the size of a display device is large, then a large number of columns of dimming zones can be designed.

Since the blue light LED lamp strings 21 are arranged corresponding to the columns of dimming zones, the number of blue light LED lamp strings 21 is the same as the number of columns of dimming zones; and since the white light LED lamp strings 31, and the ultraviolet

LED lamp strings 32 are arranged respectively corresponding to the columns of dimming zones, both the numbers of white light LED lamp strings 31, and of ultraviolet LED lamp strings 32 are the same as the number of columns of dimming zones.

In the embodiment as illustrated in FIG. 1, the light guide plate 1 includes nine dimming zones in three rows and three columns, where the number of blue light LED lamp strings 21 is three, the white light LED lamp strings 31 is three, and the ultraviolet LED lamp strings 32 is three, that is, the second LED lamp bar 3 includes six strings of LED lamps.

Referring to FIG. 1, a particular principle of local dimming of the backlight module according to this embodiment is as follows:

Blue light emitted by any one of the blue light LED lamp strings 21 in the first LED lamp bar 2 enters the light guide plate 1 so that the blue light can excite the yellow phosphor in the dimming zone in the first row and the corresponding column to generate white light, and is absorbed by the blue light absorbent in the dimming zone in the second row and the corresponding column, and thus can not enter the dimming zone in the third row and the corresponding column;

White light emitted by any one of the white light LED lamp strings 31 in the second LED lamp bar 3 enters the light guide plate 1 so that the white light can be transmitted and emitted from the light-exiting surface of the dimming zone in the third row and the corresponding column; and

Ultraviolet light emitted by any one of the ultraviolet LED lamp strings 32 in the second LED lamp bar 3 enters the light guide plate 1 so that the ultraviolet light can excite the white phosphor in the dimming zone in the second row and the corresponding column to generate white light, and is absorbed by the ultraviolet absorbent in the dimming zone in the first row and the corresponding column.

As can be apparent, with this structural design, the light emitted by the respective dimming zones of the light guide plate 1 is white light, and since the control circuits of the respective blue light LED lamp strings 21, white light LED lamp strings 31, and ultraviolet LED lamp strings 32 are separate, the brightness of the respective strings of lamps can be controlled by controlling their voltage to thereby achieve local dimming of the backlight module so as to improve the quality of a display on the display device, and to low power consumption thereof.

For example, in the picture displayed on the display device, the part thereof corresponding to the dimming zone in the third row and the first column is displayed dark, and the remaining parts thereof corresponding to the other dimming zones are displayed bright, so the two bars of LED lamps in the backlight module can be controlled in such a way that the three blue light LED lamp strings 21 in the first LED lamp bar 2 are bright, the white light LED lamp string 31 and the ultraviolet LED lamp string 32 in the second LED lamp bar 3 corresponding to the second column of dimming zones and the third column of dimming zones are bright, the ultraviolet LED lamp string 32 in the second LED lamp bar 3 corresponding to the first column of dimming zones is bright, and the white light LED lamp string 31 in the second LED lamp bar 3 corresponding to the first column of dimming zones is dark.

As illustrated in FIG. 1, in this preferred embodiment, white light LED lamps in the white light LED lamp strings 31, and ultraviolet LED lamps in the ultraviolet LED lamp strings 32 are arranged alternately. This design can achieve good uniformity of brightness in the respective dimming zones.

As illustrated in FIG. 2, in this preferred embodiment, the first coating 11 is structured in two layers which are an ultraviolet absorbent layer 11a and a yellow phosphor layer 11b respectively, where the ultraviolet absorbent layer 11a is close to the light-exiting surface of the first row of dimming zones of the light guide plate 1; and the second coating 12 is structured in two layers which are a blue light absorbent layer 12a and a white phosphor layer 12b respectively, where the blue light absorbent layer 12a is close to the light-exiting surface of the second row of dimming zones of the light guide plate 1.

The blue light absorbent layer 12a in the second coating 12 is close to a light-exiting surface of the light guide plate 1, and can absorb all the incident blue light to thereby prevent the blue light from being incident in the third row of dimming zones, so relatively pure white light can be emitted in the third row of dimming zones. The ultraviolet absorbent layer 11a in the first coating 11 is close to the light-exiting surface of the light guide plate 1, and can absorb all the incident ultraviolet to thereby alleviate the ultraviolet from illuminating the yellow phosphor layer, so relatively pure white light can be emitted in the first row of dimming zones.

Moreover in another embodiment of the disclosure, the first coating can alternatively be structured in a single layer including an ultraviolet absorbent and yellow phosphor, and the second coating can alternatively be structured in a single layer including a blue light absorbent and white phosphor.

As per the three primary colors of colored light, red phosphor and green phosphor can be mixed at the same proportion to thereby appear yellow, and red phosphor, green phosphor, and blue phosphor can be mixed at the same proportion to thereby appear white, so in a further embodiment of the disclosure, the yellow phosphor can alternatively include red phosphor and green phosphor mixed at the same proportion; and the white phosphor can alternatively include red phosphor, green phosphor, and blue phosphor mixed at the same proportion.

An embodiment of the disclosure further provides a display module including the backlight module according to any one of the technical solutions above. The backlight module in the display module can enable local dimming to thereby improve the quality of a picture on the display device, and low power consumption thereof.

An embodiment of the disclosure further provides a display device including the display module according to the technical solution above. The display device will not be limited to any particular type, for example, the display device can be a liquid crystal TV set, a liquid crystal display, a display screen of a mobile phone, etc.

While a picture is being displayed on the display device, the brightness in a dimming zone of the backlight module corresponding to a brighter part of the picture is higher, and the brightness in a dimming zone of the backlight module corresponding to a darker part of the picture is lower, thus improving the contrast throughout the displayed picture to thereby achieve a high quality of the picture, and to low power consumption of the display device.

Lastly it shall be noted that the respective embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof and these modifications or substitutions to the corresponding technical solution shall also fall into the spirit and scope of the disclosure as claimed.

1-8. (canceled)

9. A backlight module, comprising a light guide plate, a first LED lamp bar, and a second LED lamp bar, wherein:
the light guide plate comprises dimming zones in three rows and several columns, wherein a first coating comprising an ultraviolet absorbent and yellow phosphor is arranged on a light-exiting surface of a first row of dimming zones; and a second coating comprising a blue light absorbent and white phosphor is arranged on a light-exiting surface of a second row of dimming zones;
the first LED lamp bar is arranged on the side of the light guide plate close to the first row of dimming zones, and comprises blue light LED lamp strings arranged corresponding to the columns of dimming zones, and configured with separate control circuits; and
the second LED lamp bar is arranged on the side of the light guide plate close to a third row of dimming zones, and comprises white light LED lamp strings and ultraviolet LED lamp strings arranged corresponding to the columns of dimming zones, and configured with separate control circuits.

10. The backlight module according to claim 9, wherein white light LED lamps in the white light LED lamp strings, and ultraviolet LED lamps in the ultraviolet LED lamp strings are arranged alternately.

11. The backlight module according to claim 9, wherein the first coating is structured in two layers which are an ultraviolet absorbent layer and a yellow phosphor layer respectively, and the ultraviolet absorbent layer is close to the light-exiting surface of the first row of dimming zones of the light guide plate; or
the first coating is structured in a single layer including an ultraviolet absorbent and yellow phosphor.

12. The backlight module according to claim 9, wherein the second coating is structured in two layers which are a blue light absorbent layer and a white phosphor layer respectively, and the blue light absorbent layer is close to the light-exiting surface of the second row of dimming zones of the light guide plate; or
the second coating is structured in a single layer including a blue light absorbent and white phosphor.

13. The backlight module according to claim 9, wherein the light guide plate comprises dimming zones in three rows and three columns.

14. The backlight module according to claim 9, wherein the yellow phosphor comprises red phosphor and green phosphor mixed at a same proportion; and the white phosphor comprises red phosphor, green phosphor, and blue phosphor mixed at a same proportion.

15. A display module, comprising a backlight module, wherein the backlight module comprising a light guide plate, a first LED lamp bar, and a second LED lamp bar, wherein:
the light guide plate comprises dimming zones in three rows and several columns, wherein a first coating comprising an ultraviolet absorbent and yellow phosphor is arranged on a light-exiting surface of a first row of dimming zones; and a second coating comprising a blue light absorbent and white phosphor is arranged on a light-exiting surface of a second row of dimming zones;
the first LED lamp bar is arranged on the side of the light guide plate close to the first row of dimming zones, and comprises blue light LED lamp strings arranged corresponding to the columns of dimming zones, and configured with separate control circuits; and
the second LED lamp bar is arranged on the side of the light guide plate close to a third row of dimming zones, and comprises white light LED lamp strings and ultraviolet LED lamp strings arranged corresponding to the columns of dimming zones, and configured with separate control circuits.

16. The display module according to claim 15, wherein white light LED lamps in the white light LED lamp strings, and ultraviolet LED lamps in the ultraviolet LED lamp strings are arranged alternately.

17. The display module according to claim 15, wherein the first coating is structured in two layers which are an ultraviolet absorbent layer and a yellow phosphor layer respectively, and the ultraviolet absorbent layer is close to the light-exiting surface of the first row of dimming zones of the light guide plate; or
the first coating is structured in a single layer including an ultraviolet absorbent and yellow phosphor.

18. The display module according to claim 15, wherein the second coating is structured in two layers which are a blue light absorbent layer and a white phosphor layer respectively, and the blue light absorbent layer is close to the light-exiting surface of the second row of dimming zones of the light guide plate; or
the second coating is structured in a single layer including a blue light absorbent and white phosphor.

19. The display module according to claim 15, wherein the light guide plate comprises dimming zones in three rows and three columns.

20. The display module according to claim 15, wherein the yellow phosphor comprises red phosphor and green phosphor mixed at a same proportion; and the white phosphor comprises red phosphor, green phosphor, and blue phosphor mixed at a same proportion.

21. A display device, comprising a display module, wherein the display module comprising a backlight module, and the backlight module comprising a light guide plate, a first LED lamp bar, and a second LED lamp bar, wherein:
the light guide plate comprises dimming zones in three rows and several columns, wherein a first coating comprising an ultraviolet absorbent and yellow phosphor is arranged on a light-exiting surface of a first row of dimming zones; and a second coating comprising a blue light absorbent and white phosphor is arranged on a light-exiting surface of a second row of dimming zones;
the first LED lamp bar is arranged on the side of the light guide plate close to the first row of dimming zones, and comprises blue light LED lamp strings arranged corresponding to the columns of dimming zones, and configured with separate control circuits; and
the second LED lamp bar is arranged on the side of the light guide plate close to a third row of dimming zones, and comprises white light LED lamp strings and ultraviolet LED lamp strings arranged corresponding to the columns of dimming zones, and configured with separate control circuits.

22. The display device according to claim 21, wherein white light LED lamps in the white light LED lamp strings, and ultraviolet LED lamps in the ultraviolet LED lamp strings are arranged alternately.

23. The display device according to claim 21, wherein the first coating is structured in two layers which are an ultraviolet absorbent layer and a yellow phosphor layer respectively, and the ultraviolet absorbent layer is close to the light-exiting surface of the first row of dimming zones of the light guide plate; or
the first coating is structured in a single layer including an ultraviolet absorbent and yellow phosphor.

24. The display device according to claim 21, wherein the second coating is structured in two layers which are a blue light absorbent layer and a white phosphor layer respectively, and the blue light absorbent layer is close to the light-exiting surface of the second row of dimming zones of the light guide plate; or
the second coating is structured in a single layer including a blue light absorbent and white phosphor.

25. The display device according to claim 21, wherein the light guide plate comprises dimming zones in three rows and three columns.

26. The display device according to claim 21, wherein the yellow phosphor comprises red phosphor and green phosphor mixed at a same proportion; and the white phosphor comprises red phosphor, green phosphor, and blue phosphor mixed at a same proportion.
